(19) United States
(12) Patent Application Publication
(10) Pub. No.: US 2026/0321952 A1
(43) Pub. Date: Oct. 15, 2026

(54) POWER DIVIDER/COMBINER WITH THERMAL STACK-UP FEATURES

(71) Applicant: BAE Systems Information and Electronic Systems Integration Inc., Nashua, NH (US)

(72) Inventor: Nick Yang, Chelmsford, MA (US)

(73) Assignee: BAE Systems Information and Electronic Systems Integration Inc., Nashua, NH (US)

(21) Appl. No.: 19/174,543

(22) Filed: Apr. 9, 2025

(51) Int. Cl. H01P 5/18

(52) U.S. Cl. CPC H01P 5/185

(57) ABSTRACT

A power/divider combiner implementing the techniques according to an embodiment includes a first ground plane layer; a first ground plane layer disposed on the first substrate layer; a first and second stripline disposed on the first substrate layer, wherein the first substrate layer is configured to control impedance of the first and second stripline; a resistive foil coupling a portion of the first and second striplines to provide isolation resistance; a second substrate layer disposed over the striplines and resistive foil, wherein the thickness of the second substrate layer is greater than the thickness of the first substrate layer; a second ground plane layer disposed on the second substrate layer; and a plurality of vias configured to provide electrical coupling between the ground plane layers and to provide thermal conduction from one or more of the striplines, the resistive foil, and the substrate, to the ground plane layers.

### FIELD OF DISCLOSURE

The present disclosure relates to signal processing, and more particularly to a power divider/combiner.

### BACKGROUND

Power divider/combiners can be used in a number of applications, such as radar systems and communications systems. For example, systems that receive and/or transmit broadband signals (e.g., frequencies extending into the tens of Gigahertz and higher) typically need to combine and/or split such signals to facilitate the transmission and/or further processing of the signals. In higher power applications, the power divider/combiner may be used in conjunction with heat dissipation capability.

### BRIEF DESCRIPTION OF THE DRAWINGS

FIG. 1 is a block diagram of a phased array application configured with a power divider/combiner, in accordance with an embodiment of the present disclosure.

FIG. 2 is a schematic diagram of the power divider/combiner of FIG. 1, configured in accordance with an embodiment of the present disclosure.

FIG. 3 is a top-down cross-section view of a printed circuit board (PCB) structure implementing the power divider/combiner of FIG. 2, in accordance with an embodiment of the present disclosure.

FIG. 4 is a top-down cross-section view of a PCB structure implementing a first stage of the power divider/combiner of FIG. 2, in accordance with another embodiment of the present disclosure.

FIG. 5 is a side cross-section view of a PCB structure implementing the power divider/combiner of FIG. 2, in accordance with certain embodiments of the present disclosure.

FIG. 6 is a flowchart illustrating a methodology for fabrication of a power divider/combiner, in accordance with an embodiment of the present disclosure.

Although the following Detailed Description will proceed with reference being made to illustrative embodiments, many alternatives, modifications, and variations thereof will be apparent in light of this disclosure.

### DETAILED DESCRIPTION

Techniques are provided herein for a power divider/combiner implemented as a printed circuit board (PCB) with layer stack features configured for improved thermal characteristics and reduced size. As noted above, power divider/combiners can be used in a number of applications, such as radar systems and communications systems. For example, systems that receive and/or transmit broadband signals (e.g., frequencies extending into the tens of Gigahertz and higher) typically need to combine and/or split such signals. In higher power applications, the power divider/combiner may need to provide adequate heat dissipation capability.

To this end, and in accordance with an embodiment of the present disclosure, a power divider/combiner PCB configured with an asymmetric substrate stack is described. A thicker substrate on one side of the power divider/combiner signal traces facilitates heat transfer while a thinner substrate on the other side of the signal traces increases electric field density allowing for a narrower signal trace which facilitates a compact design for a given line impedance. A reduced impedance for the power combiner/divider ensures that the trace is wide enough to provide sufficient heat dissipation. The power divider/combiner PCB also includes a number of thermal vias positioned in relatively close proximity to the signal traces to allow additional heat transfer from the signal traces (and the power divider/combiner isolation resistor) through the one or more of the vias to ground planes above and below the signal traces. Additionally, the power divider/combiner may be designed to provide a lower characteristic impedance which allows for an isolation resistor of lower resistance. The resulting isolation resistor may have reduced surface area (e.g., decreased size) and increased thickness to allow for greater power density.

In accordance with an embodiment, a PCB-based power divider/combiner configured for improved thermal characteristics and reduced size includes a first cladding layer configured to provide a first ground plane, and on a first portion of a substrate layer. The power divider/combiner also includes a first and second stripline on the first portion of the substrate layer. The second stripline is parallel to and offset from the first stripline. The first portion of the substrate layer is configured to control impedance of the first stripline and the second stripline. The power divider/combiner further includes a resistive foil on the first portion of the substrate layer and coupling a portion of the first stripline to a portion of the second stripline and configured to provide isolation resistance. The power divider/combiner further includes a second portion of the substrate layer over the first stripline, the second stripline, and the resistive foil. In an example, the thickness of the second portion of the substrate layer is greater than the thickness of the first portion of the substrate layer. Other examples may be reversed and have a thicker first portion. The power divider/combiner further includes a second cladding layer disposed on the second portion of the substrate layer. The second cladding layer is configured to provide a second ground plane. The power divider/combiner further includes a plurality of vias configured to provide electrical coupling of the first cladding layer to the second cladding layer, and to provide thermal conduction from one or more of the first stripline, the second stripline, the resistive foil, and the substrate, to the first cladding layer and the second cladding layer.

It will be appreciated that the techniques described herein may provide for a power divider/combiner with improved thermal characteristics and reduced size. Numerous embodiments and applications will be apparent in light of this disclosure.

### System Architecture

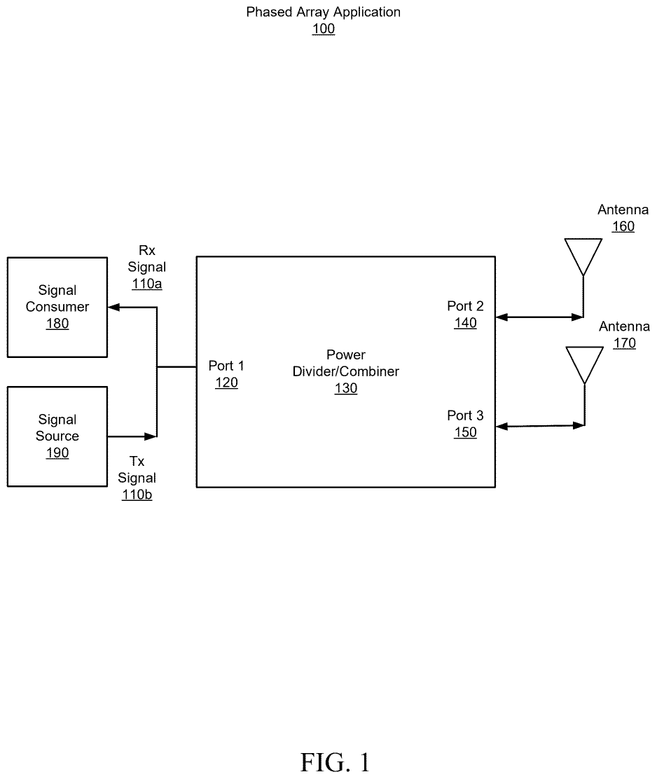

FIG. 1 is a block diagram of a phased array application 100, configured in accordance with certain embodiments of the present disclosure. The phased array application 100 is shown to include antennas 160 and 170, power divider/combiner 130, signal consumer 180, and signal source 190. Additional components such as amplifiers, filters, and the like may also be included but are not shown in this example for simplicity.

When operating in a receive mode, the antennas 160 and 170 are configured to receive signals that have been transmitted from one or more emitting sources. The power divider/combiner 130 is configured to combine the signals received from antennas 160 and 170, at the input ports 140 and 150, respectively, into a combined received signal 110a at the output port 120. The combined signal 110a may then be provided to the signal consuming circuit or application 180 that is configured to analyze or otherwise act on that signal. The signal consuming circuit or application 180 may further process (e.g., filter) signal 110a and apply that signal to one or more further circuits. The signal consuming circuit or application 180 may be configured for any application (e.g., radar systems, tracking systems, targeting systems, communications systems).

When operating in a transmit mode, a signal source circuit or application 190 is configured to generate a signal 110b that is to be transmitted. In the transmit mode, the signal direction is reversed, for example, the port coupled to the signal source is an input port and the ports coupled to the antennas are output ports. Just as the signal consuming circuit or application 180, the signal source circuit 190 may be configured for any application (e.g., radar systems, tracking systems, targeting systems, communications systems). The signal 110b is provided to the power divider/combiner 130 at the input port 120 so that the signal can be split and provided to antennas 160 and 170 at the output ports 140 and 150, respectively.

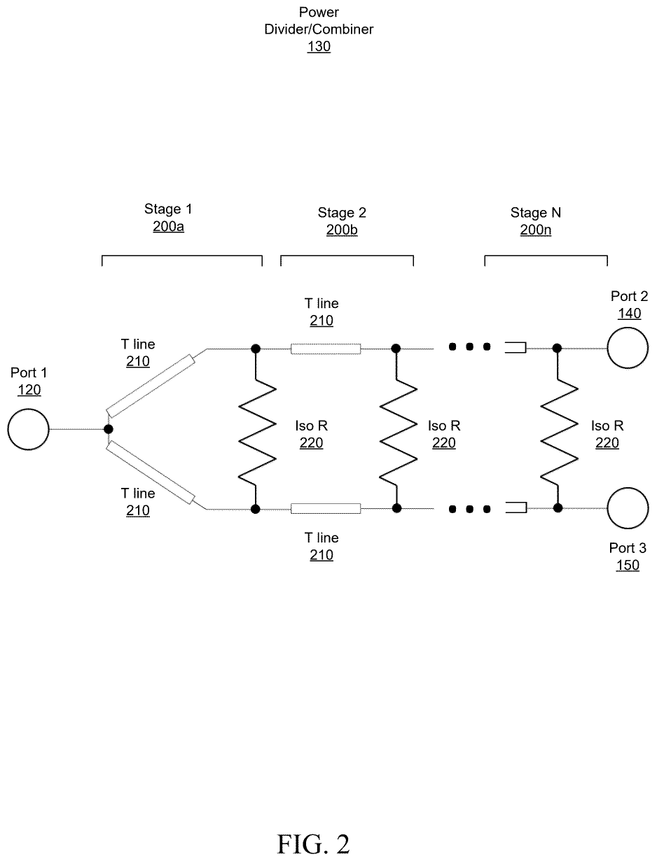

FIG. 2 is a schematic diagram of the power divider/combiner 130 of FIG. 1, configured in accordance with certain embodiments of the present disclosure. The power divider/combiner 130 may be used in receive and/or transmit applications such, for example, as the phased array application 100 shown in FIG. 1. The power divider/combiner 130 in this example is configured as a multi-stage divider/combiner which may be suitable for operation on broadband signals.

The power divider/combiner 130 is shown to include three ports 120, 140, and 150 and two or more cascaded stages (e.g., stage 1 200a, stage 2 200b, . . . stage N 200n). Each stage includes two transmission lines 210 and an isolation resistor 220 between the transmission lines of that stage. The number of stages to be employed may be selected based on a high frequency cutoff requirement for the divider/combiner. For example, additional stages increase the bandwidth of the divider/combiner

When functioning as a power combiner, the circuit 130 receives input signals at port 2 (140) and port 3 (150) and combines them into an output signal to be provided at port 1 (120). When functioning as a power splitter, the circuit 200 receives an input signal at port 1 (120) and splits that signal into two output signals to be provided at port 2 (140) and port 3 (150).

The transmission lines 210 are configured to be of a length that is one quarter of the wavelength associated with the frequency of the signal of interest to be received or transmitted.

The isolation resistors R 220 provide coupling between the transmission lines of each stage and are configured to provide isolation between ports 2 and 3. The values of the isolation resistors increase with the number of cascaded stages. The isolation resistor values may be determined empirically or through simulation, based on the desired impedance to be achieved by the divider/combiner.

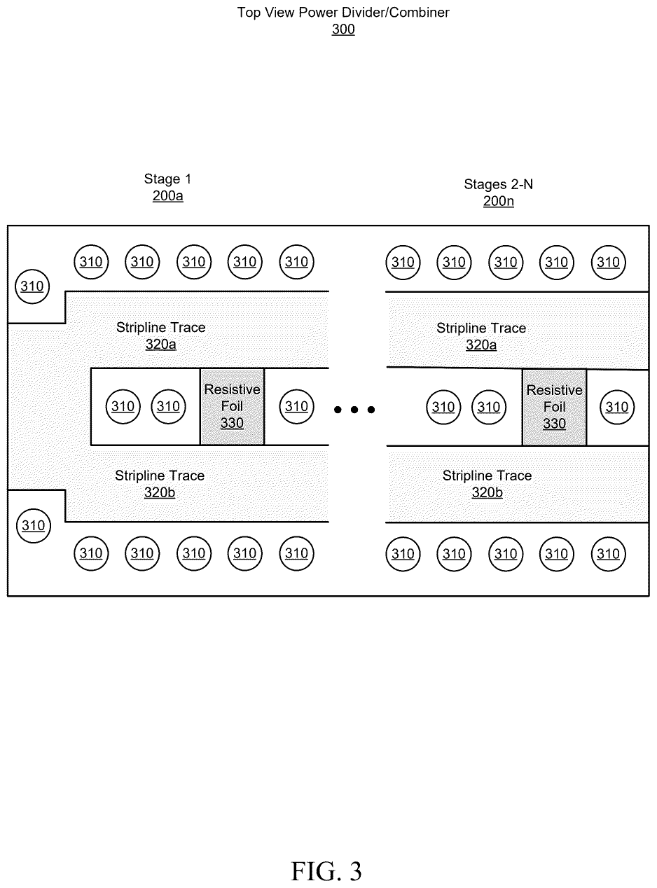

FIG. 3 is a top-down cross-section view 300 of a printed circuit board (PCB) structure implementing the power divider/combiner 130 of FIG. 2, in accordance with an embodiment of the present disclosure. The transmission lines 210 are implemented as signal traces or stripline traces 320a and 320b. The isolation resistors 220 in this embodiment are implemented as resistive foils or thin film resistive material 330 which couple between portions of the stripline traces 320a and 320b. The stripline traces 320a and 320b of the first stage 200a combine (e.g., on the left side of the figure) to couple to port 1 (120). The stripline traces 320a and 320b of the final stage 200n are coupled to port 2 (140) and port 3 (150) respectively. A number of vias 310 are also shown, which pass through the layers of the PCB, and provide thermal conduction, as will be described in greater detail below.

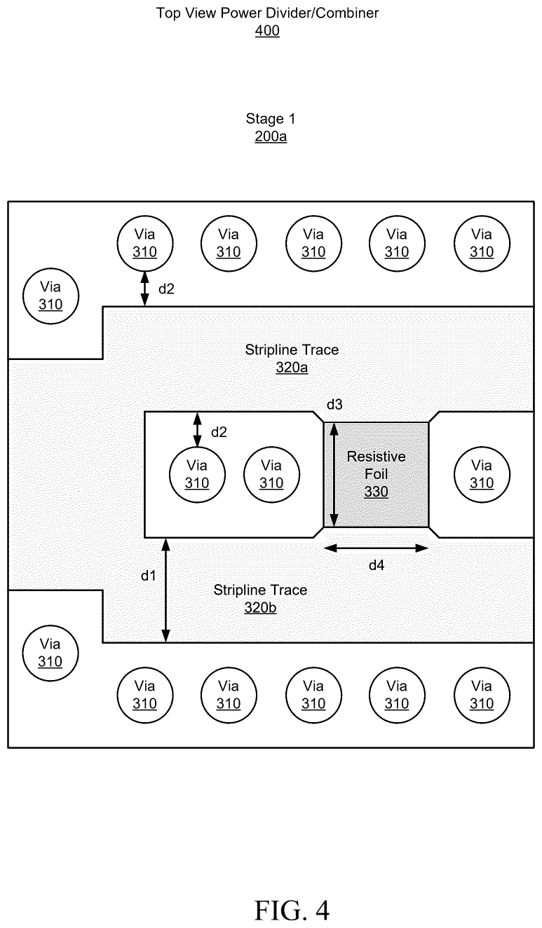

FIG. 4 is a top-down cross-section view 400 of a PCB structure implementing a first stage 200a of the power divider/combiner 130 of FIG. 2, in accordance with another embodiment of the present disclosure. Although this view relates to the first stage 200a, the description is applicable to the following stages (stages 2 through N) with the exception that the striplines of those stages do not combine as they do for port 1 (120) in the first stage.

The width of the stripline traces 320 is shown to be d1. In some embodiments, the line width d1 is chosen to be wide enough to adequately handle DC and RF current levels (e.g., to avoid fusing of the traces). The width will depend on the dielectric substrate and trace material.

The distance from the vias 310 to the stripline traces 320 is shown to be d2. In some embodiments, the distance d2 is chosen to be a minimum distance that is consistent with PCB manufacturing capabilities. For example, although a reduced distance d2 is desired, as the number of layers in the PCB increase and the number of lamination operations increase, the distance between the vias 310 and the edging of the traces 320 should increase to avoid the formation of drill cracks around the traces. An additional consideration is that a reduced distance d2 can decrease the impedance of the combiner/divider. In some embodiments, it is desirable that any resulting impedance change is limited to less than 20 percent.

The resistive foil 330 is shown to have a width d3 and a length d4. The dimensions d3 and d4 are dependent on the resistive properties of the resistive foil and may be selected to achieve the desired stripline impedance to meet application requirements. In some embodiments, d3 and d4 are also chosen to be minimum values that are consistent with PCB manufacturing capabilities and to adequately handle DC and RF current levels.

The relatively large number of thermal vias 310 positioned in close proximity to the stripline traces (including between the traces) improve heat transfer from the traces and the resistive foil through the vias to the ground planes.

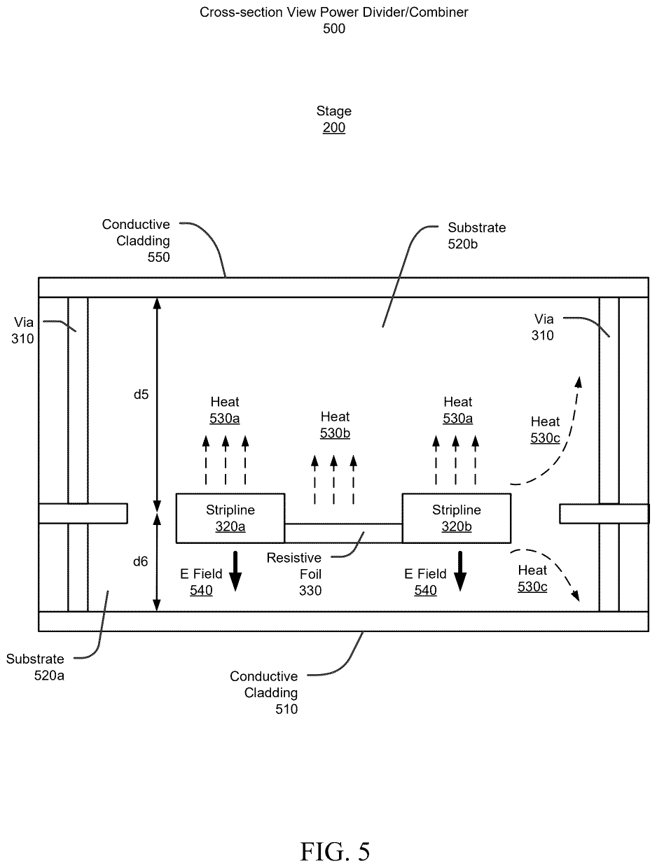

FIG. 5 is a side cross-section view 500 of a PCB structure implementing the power divider/combiner 130 of FIG. 2, in accordance with certain embodiments of the present disclosure. The cross-section view 500 of the power divider/combiner PCB 130 shows a number of layers. Proceeding from bottom to top, a first conductive cladding layer 510 is configured to provide a first ground plane. Next, a first portion 520a of a substrate layer 520 is shown to be clad by the first cladding layer 510.

A first stripline trace 320a and a second stripline trace 320b are disposed on the first portion 520a of the substrate layer. The second stripline 320b is positioned parallel to and offset from the first stripline 320a.

A resistive foil 330 couples a portion of the first stripline 320a to a portion of the second stripline 320b and is configured to provide isolation resistance for the power divider/combiner.

A second portion 520b of the substrate layer 520 is disposed over the first stripline 320a, the second stripline 320b, and the resistive foil 330. The thickness d5 of the second portion 520b of the substrate layer is greater than the thickness d6 of the first portion 520a of the substrate layer. In some embodiments, the thickness d6 of the first portion of the substrate layer is greater than 3 mils and the thickness d5 of the second portion 520b of the substrate layer is greater than 10 mils. In some embodiments, the substrate layer 520 is a dielectric material. In some embodiments, a suspended substrate in which air is employed as a dielectric.

The first portion 520a of the substrate layer is configured to control the impedance of the first and second striplines 320a and 320b, and by extension the impedance of the power divider/combiner. The relative thinness d6 of the first portion 520 of the substrate layer concentrates the electric field 540 generated by the striplines 320 which allows for control of the impedance based on that dimension (d6). In some embodiments, by designing the power divider/combiner to have a lower impedance, the isolation resistors can be configured to a lower resistance value which allows for the resistive foil 330 to be thicker which in turn will provide increased thermal capacity. A lower power divider/combiner impedance also allows for an increased stripline width, which further improves heat dissipation as the stripline acts as a heat sink to transfer heat to the surrounding substrate dielectric material.

The substrate layer 520 is also configured to provide a heat sink for the first and second striplines 320a and 320b, and the resistive foil 330. As shown, heat 530a may be conducted from the striplines 320 into the substrate 520 and heat 530b may be conducted from the resistive foil 330 into the substrate 520. The heat sink may provide thermal conduction to the first cladding layer, the second cladding layer, and the plurality of vias, as described below.

A second conductive cladding layer 550 is disposed on the second portion 520b of the substrate layer. The second conductive cladding layer 550 is configured to provide a second ground plane. In some embodiments, the first and second conductive cladding layers, 510 and 550, are copper or another suitably conductive material.

Two vias, of the plurality of vias 310, are shown in this Figure and are configured to provide electrical coupling of the first cladding layer 510 to the second cladding layer 550. The vias 310 are also configured to provide thermal conduction 530c from the striplines 320a and 320b, the resistive foil 330, and the substrate 520, to the first and second cladding layers 510 and 550. Additionally, some of the heat (e.g., 530a and 530b) may be conducted or dissipated through the substrate 520 directly to the cladding layers.

The vias provide thermal relief and metal shielding between the combiner branches. To achieve isolation, the via spacing may be at least ⅛ of the signal wavelength in the dielectric. For example, given a dielectric constant of 3.0, the via spacing would be 35 mil or less. The via spacing may also depend on the substrate stack-up. For example, using a single lamination and single plating with less than 8 copper layers and a via drill size of 3.5 mil radius, the via spacing would be greater than 33 mil. In this example, then, a single stage can fit 3 drilled vias to achieve reasonable isolation and thermal relief.

In one example embodiment, for which a 10 Ohm terminal impedance is desired for operation over a frequency range of 2 GHz to 20 GHz, a stage divider may be configured with the following design parameters:

| | Stage #1 | | Stage #2 | | Stage #3 | | Stage #4 | | Stage #5 | | Stage #6 | |
|---|---|---|---|---|---|---|---|---|---|---|---|---|
| Sub Height | 15 | mil | 15 | mil | 15 | mil | 15 | mil | 15 | mil | 15 | mil |
| Stripline | 18.44 | Ω | 16.19 | Ω | 14.83 | Ω | 13.52 | Ω | 12.37 | Ω | 11.45 | Ω |
| Impedance | | | | | | | | | | | | |
| Stripline | 33 | mil | 39 | mil | 43 | mil | 48 | mil | 53 | mil | 58 | mil |
| Width | | | | | | | | | | | | |
| Stripline | 135 mil-145 mil | | 135 mil-145 mil | | 135 mil-145 mil | | 135 mil-145 mil | | 135 mil-145 mil | | 135 mil-145 mil | |
| Length | | | | | | | | | | | | |
| Isolation | 20 | Ω | 20 | Ω | 50 | Ω | 50 | Ω | 100 | Ω | 100 | Ω |
| Resistor | | | | | | | | | | | | |
| value | | | | | | | | | | | | |
| Resistive film | 15 | mil | 15 | mil | 13 | mil | 13 | mil | 13 | mil | 13 | mil |
| Width | | | | | | | | | | | | |
| Resistive film | 6 | mil | 6 | mil | 15.6 | mil | 15.6 | mil | 26 | mil | 26 | mil |
| length | | | | | | | | | | | | |

| | | | | | | |
|---|---|---|---|---|---|---|
| Number of | 3 | 3 | 3 | 3 | 3 | 3 |
| Via | | | | | | |

### Methodology

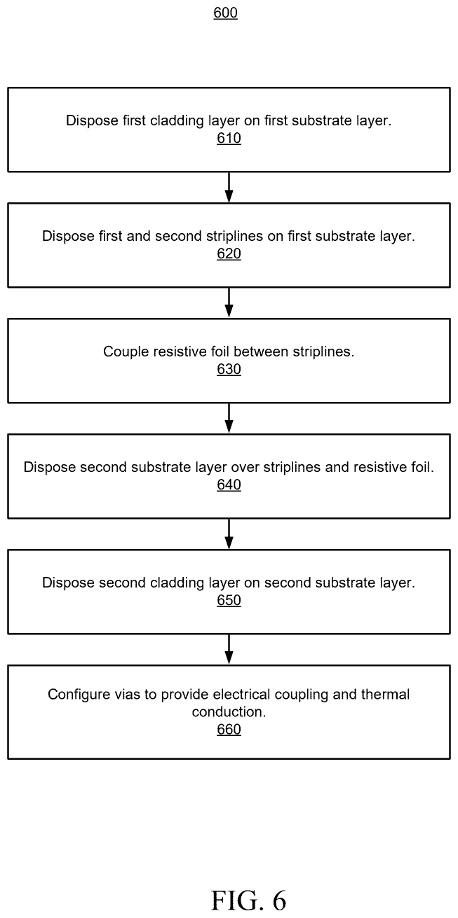

FIG. 6 is a flowchart illustrating a methodology 600 for fabrication of a power divider/combiner, in accordance with an embodiment of the present disclosure. As can be seen, example method 600 includes a number of phases and sub-processes, the sequence of which may vary from one embodiment to another. However, when considered in aggregate, these phases and sub-processes form a process for fabrication of a power divider/combiner, for example as a PCB, in accordance with certain of the embodiments disclosed herein, for example as illustrated in FIGS. 1-5, as described above. However other system architectures can be used in other embodiments, as will be apparent in light of this disclosure. To this end, the correlation of the various functions shown in FIG. 6 to the specific components illustrated in the figures, is not intended to imply any structural and/or use limitations. Rather other embodiments may include, for example, varying degrees of integration wherein multiple functionalities are effectively performed by one system. Numerous variations and alternative configurations will be apparent in light of this disclosure.

In one embodiment, method 600 commences, at operation 610, by disposing a first cladding layer on a first portion of a substrate layer. The first cladding layer is configured to provide a first ground plane.

At operation 620, first and second striplines are disposed on the first portion of the substrate layer. In some embodiments, the second stripline runs parallel to and offset from the first stripline. The first portion of the substrate layer is configured to control the impedance of the first stripline and second stripline.

At operation 630, a resistive foil is coupled to a portion of the first stripline and to a portion of the second stripline. In some embodiments, the resistive foil is configured to provide isolation resistance.

At operation 640, a second portion of the substrate layer is disposed over the first stripline, the second stripline, and the resistive foil. The thickness of the second portion of the substrate layer is greater than the thickness of the first portion of the substrate layer. The substrate layer is configured to provide a heat sink for the first stripline, the second stripline, and the resistive foil. The heat sink may provide thermal conduction to the first cladding layer, the second cladding layer, and the plurality of vias. In some embodiments, the substrate layer is a dielectric.

At operation 650, a second cladding layer is disposed on the second portion of the substrate layer. The second cladding layer is configured to provide a second ground plane. In some embodiments, the first and second cladding layers are copper or another suitable conductive material.

At operation 660, vias are configured to provide electrical coupling of the first cladding layer to the second cladding layer and to provide thermal conduction from the first stripline, the second stripline, the resistive foil, and the substrate, to the first and second cladding layers.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood, however, that other embodiments may be practiced without these specific details, or otherwise with a different set of details. It will be further appreciated that the specific structural and functional details disclosed herein are representative of example embodiments and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.
Example 1 is a power divider/combiner comprising: a first portion of a substrate layer, the first portion of the substrate layer having a first thickness; a first cladding layer on the first portion of the substrate layer and configured to provide a first ground plane; a first stripline on the first portion of the substrate layer; a second stripline on the first portion of the substrate layer, the second stripline parallel to and offset from the first stripline, wherein the first portion of the substrate layer is configured to control impedance of the first stripline and the second stripline; a resistive foil coupling a portion of the first stripline to a portion of the second stripline and configured to provide isolation resistance; a second portion of the substrate layer over the first stripline, the second stripline, and the resistive foil, the second portion of the substrate layer having a second thickness that is either greater than or less than the first thickness of the first portion of the substrate layer; a second cladding layer on the second portion of the substrate layer, the second cladding layer configured to provide a second ground plane; and a plurality of vias configured to provide electrical coupling of the first cladding layer to the second cladding layer and to provide thermal conduction from one or more of the first stripline, the second stripline, the resistive foil, and the substrate, to the first cladding layer and the second cladding layer.
Example 2 includes the power divider/combiner of Example 1, wherein the substrate layer is configured to provide a heat sink for the first stripline, the second stripline, and the resistive foil, the heat sink to provide thermal conduction to the first cladding layer, the second cladding layer, and the plurality of vias.
Example 3 includes the power divider/combiner of Examples 1 or 2, wherein the thickness of the first portion of the substrate layer is greater than 3 mils and the thickness of the second portion of the substrate layer is greater than 10 mils.
Example 4 includes the power divider/combiner of any of Examples 1-3, wherein a width of the resistive foil and a length of the resistive foil are minimum values based on current handling requirements of the power divider/combiner.
Example 5 includes the power divider/combiner of any of Examples 1-4, wherein a width of the first stripline and a width of the second stripline are based on current handling requirements of the power divider/combiner.
Example 6 includes the power divider/combiner of any of Examples 1-5, wherein the substrate layer is a dielectric.
Example 7 includes the power divider/combiner of any of Examples 1-6, wherein the first cladding layer and the second cladding layer are copper.
Example 8 includes the power divider/combiner of any of Examples 1-7, wherein the power divider/combiner is configured as a printed circuit board.
Example 9 is a power divider/combiner comprising: a plurality of stages, each stage comprising a first portion of a substrate layer, the first portion of the substrate layer having a first thickness, a first cladding layer on the first portion of the substrate layer and configured to provide a first ground plane, a first stripline on the first portion of the substrate layer, a second stripline on the first portion of the substrate layer, the second stripline parallel to and offset from the first stripline, wherein the first portion of the substrate layer is configured to control impedance of the first stripline and the second stripline, a resistive foil coupling a portion of the first stripline to a portion of the second stripline and configured to provide isolation resistance, a second portion of the substrate layer over the first stripline, the second stripline, and the resistive foil, the second portion of the substrate layer having a second thickness that is either greater than or less than the first thickness of the first portion of the substrate layer, a second cladding layer on the second portion of the substrate layer, the second cladding layer configured to provide a second ground plane, and a plurality of vias configured to provide electrical coupling of the first cladding layer to the second cladding layer and to provide thermal conduction from one or more of the first stripline, the second stripline, the resistive foil, and the substrate, to the first cladding layer and the second cladding layer; wherein a first of the stages comprises a first port coupled to the first stripline of the first stage and to the second strip line of the first stage; and wherein a last of the stages comprises a second port coupled to the first stripline of the last stage and a third port coupled to the second stripline of the last stage.
Example 10 includes the power divider/combiner of Example 9, wherein the substrate layer is configured to provide a heat sink for the first stripline, the second stripline, and the resistive foil, the heat sink to provide thermal conduction to the first cladding layer, the second cladding layer, and the plurality of vias.
Example 11 includes the power divider/combiner of Examples 9 or 10, wherein the thickness of the first portion of the substrate layer is greater than 3 mils and the thickness of the second portion of the substrate layer is greater than 10 mils.
Example 12 includes the power divider/combiner of any of Examples 9-11, wherein a width of the resistive foil and a length of the resistive foil are minimum values based on current handling requirements of the power divider/combiner.
Example 13 includes the power divider/combiner of any of Examples 9-12, wherein a width of the first stripline and a width of the second stripline are based on current handling requirements of the power divider/combiner.
Example 14 includes the power divider/combiner of any of Examples 9-13, wherein the substrate layer is a dielectric and the first cladding layer and the second cladding layer are copper.
Example 15 includes the power divider/combiner of any of Examples 9-14, wherein the power divider/combiner is configured as a printed circuit board.
Example 16 is a radio frequency (RF) communication system comprising the power divider/combiner of any one of Examples 1 through 15.
Example 17 is a method for fabrication of a power divider/combiner printed circuit board, the method comprising: disposing a first cladding layer on a first portion of a substrate layer, the first portion of the substrate layer having a first thickness, the first cladding layer configured to provide a first ground plane; disposing a first stripline on the first portion of the substrate layer; disposing a second stripline on the first portion of the substrate layer, the second stripline parallel to and offset from the first stripline, wherein the first portion of the substrate layer is configured to control impedance of the first stripline and the second stripline; coupling a resistive foil to a portion of the first stripline and to a portion of the second stripline, the resistive foil configured to provide isolation resistance; disposing a second portion of the substrate layer over the first stripline, the second stripline, and the resistive foil, the second portion of the substrate layer having a second thickness that is either greater than or less than the first thickness of the first portion of the substrate layer; disposing a second cladding layer on the second portion of the substrate layer, the second cladding layer configured to provide a second ground plane; and configuring a plurality of vias to provide electrical coupling of the first cladding layer to the second cladding layer and to provide thermal conduction from one or more of the first stripline, the second stripline, the resistive foil, and the substrate, to the first cladding layer and the second cladding layer.
Example 18 includes the method of Example 17, wherein the thickness of the first portion of the substrate layer is greater than 3 mils and the thickness of the second portion of the substrate layer is greater than 10 mils.
Example 19 includes the method of Examples 17 or 18, wherein a width of the resistive foil and a length of the resistive foil are minimum values based on current handling requirements of the power divider/combiner.
Example 20 includes the method of any of Examples 17-19, wherein a width of the first stripline and a width of the second stripline are based on current handling requirements of the power divider/combiner.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

1. A power divider/combiner comprising:
a first portion of a substrate layer, the first portion of the substrate layer having a first thickness;
a first cladding layer on the first portion of the substrate layer and configured to provide a first ground plane;
a first stripline on the first portion of the substrate layer;
a second stripline on the first portion of the substrate layer, the second stripline parallel to and offset from the first stripline, wherein the first portion of the substrate layer is configured to control impedance of the first stripline and the second stripline;
a resistive foil coupling a portion of the first stripline to a portion of the second stripline and configured to provide isolation resistance;
a second portion of the substrate layer over the first stripline, the second stripline, and the resistive foil, the second portion of the substrate layer having a second thickness that is either greater than or less than the first thickness of the first portion of the substrate layer;
a second cladding layer on the second portion of the substrate layer, the second cladding layer configured to provide a second ground plane; and
a plurality of vias configured to provide electrical coupling of the first cladding layer to the second cladding layer and to provide thermal conduction from one or more of the first stripline, the second stripline, the resistive foil, and the substrate, to the first cladding layer and the second cladding layer.

2. The power divider/combiner of claim 1, wherein the substrate layer is configured to provide a heat sink for the first stripline, the second stripline, and the resistive foil, the heat sink to provide thermal conduction to the first cladding layer, the second cladding layer, and the plurality of vias.

3. The power divider/combiner of claim 1, wherein the thickness of the first portion of the substrate layer is greater than 3 mils and the thickness of the second portion of the substrate layer is greater than 10 mils.

4. The power divider/combiner of claim 1, wherein a width of the resistive foil and a length of the resistive foil are minimum values based on current handling requirements of the power divider/combiner.

5. The power divider/combiner of claim 1, wherein a width of the first stripline and a width of the second stripline are based on current handling requirements of the power divider/combiner.

6. The power divider/combiner of claim 1, wherein the substrate layer is a dielectric.

7. The power divider/combiner of claim 1, wherein the first cladding layer and the second cladding layer are copper.

8. The power divider/combiner of claim 1, wherein the power divider/combiner is configured as a printed circuit board.

9. A power divider/combiner comprising:
a plurality of stages, each stage comprising
a first portion of a substrate layer, the first portion of the substrate layer having a first thickness,
a first cladding layer on the first portion of the substrate layer and configured to provide a first ground plane,
a first stripline on the first portion of the substrate layer,
a second stripline on the first portion of the substrate layer, the second stripline parallel to and offset from the first stripline, wherein the first portion of the substrate layer is configured to control impedance of the first stripline and the second stripline,
a resistive foil coupling a portion of the first stripline to a portion of the second stripline and configured to provide isolation resistance,
a second portion of the substrate layer over the first stripline, the second stripline, and the resistive foil, the second portion of the substrate layer having a second thickness that is either greater than or less than the first thickness of the first portion of the substrate layer,
a second cladding layer on the second portion of the substrate layer, the second cladding layer configured to provide a second ground plane, and
a plurality of vias configured to provide electrical coupling of the first cladding layer to the second cladding layer and to provide thermal conduction from one or more of the first stripline, the second stripline, the resistive foil, and the substrate, to the first cladding layer and the second cladding layer;
wherein a first of the stages comprises a first port coupled to the first stripline of the first stage and to the second strip line of the first stage; and
wherein a last of the stages comprises a second port coupled to the first stripline of the last stage and a third port coupled to the second stripline of the last stage.

10. The power divider/combiner of claim 9, wherein the substrate layer is configured to provide a heat sink for the first stripline, the second stripline, and the resistive foil, the heat sink to provide thermal conduction to the first cladding layer, the second cladding layer, and the plurality of vias.

11. The power divider/combiner of claim 9, wherein the thickness of the first portion of the substrate layer is greater than 3 mils and the thickness of the second portion of the substrate layer is greater than 10 mils.

12. The power divider/combiner of claim 9, wherein a width of the resistive foil and a length of the resistive foil are minimum values based on current handling requirements of the power divider/combiner.

13. The power divider/combiner of claim 9, wherein a width of the first stripline and a width of the second stripline are based on current handling requirements of the power divider/combiner.

14. The power divider/combiner of claim 9, wherein the substrate layer is a dielectric and the first cladding layer and the second cladding layer are copper.

15. The power divider/combiner of claim 9, wherein the power divider/combiner is configured as a printed circuit board.

16. A radio frequency (RF) communication system comprising the power divider/combiner of claim 1.

17. A method for fabrication of a power divider/combiner printed circuit board, the method comprising:
disposing a first cladding layer on a first portion of a substrate layer, the first portion of the substrate layer having a first thickness, the first cladding layer configured to provide a first ground plane;
disposing a first stripline on the first portion of the substrate layer;
disposing a second stripline on the first portion of the substrate layer, the second stripline parallel to and offset from the first stripline, wherein the first portion of the substrate layer is configured to control impedance of the first stripline and the second stripline;
coupling a resistive foil to a portion of the first stripline and to a portion of the second stripline, the resistive foil configured to provide isolation resistance;
disposing a second portion of the substrate layer over the first stripline, the second stripline, and the resistive foil, the second portion of the substrate layer having a second thickness that is either greater than or less than the first thickness of the first portion of the substrate layer;
disposing a second cladding layer on the second portion of the substrate layer, the second cladding layer configured to provide a second ground plane; and
configuring a plurality of vias to provide electrical coupling of the first cladding layer to the second cladding layer and to provide thermal conduction from one or more of the first stripline, the second stripline, the resistive foil, and the substrate, to the first cladding layer and the second cladding layer.

18. The method of claim 17, wherein the thickness of the first portion of the substrate layer is greater than 3 mils and the thickness of the second portion of the substrate layer is greater than 10 mils.

19. The method of claim 17, wherein a width of the resistive foil and a length of the resistive foil are minimum values based on current handling requirements of the power divider/combiner.

20. The method of claim 17, wherein a width of the first stripline and a width of the second stripline are based on current handling requirements of the power divider/combiner.
